(19) United States
(12) Patent Application Publication
(10) Pub. No.: US 2019/0270590 A1
(43) Pub. Date: Sep. 5, 2019

(54) Logistics System

(71) Applicant: Westfalia Intralogistic GmbH, Halle/Westfalen (DE)

(72) Inventor: Peter HÖPFNER, Steinhagen (DE)

(21) Appl. No.: 16/365,495

(22) Filed: Mar. 26, 2019

Related U.S. Application Data
(63) Continuation of application No. PCT/EP2017/074324, filed on Sep. 26, 2017.

(30) Foreign Application Priority Data
Sep. 27, 2016 (DE) 10 2016 118 276.1
Aug. 28, 2017 (DE) 10 2017 119 627.7
Aug. 30, 2017 (DE) 10 2017 119 928.4

(51) Int. Cl. B65G 1/137; B65G 1/04; B65G 1/16

(52) U.S. Cl. CPC B65G 1/1375; B65G 1/16; B65G 1/0457

(57) ABSTRACT

A logistics system for carrying out a logistics process. The logistics system having a plurality of automated overhead rack storage and retrieval apparatuses for transporting loads to be transported within the scope of the logistics process. A process zone that is essentially free of storage racks is provided on the floor, and a storage zone is situated above the process zone. A plurality of pick-up or drop-off points at which loads may be picked up or dropped off by the rack storage and retrieval apparatuses is defined along the process zone base area of the process zone. The logistics system may also have a transfer apparatus for transferring the rack storage and retrieval apparatuses.

### CROSS-REFERENCE TO RELATED APPLICATIONS

This application is a continuation of application no. PCT/EP2017/074324, filed 26 Sep. 2017, and this application claims the priority of German Application No. 10 2016 118 276.1, filed 27 Sep. 2016, and this application claims the priority of German Application No. 10 2017 119 627.7, filed 28 Aug. 2017, and this application claims the priority of German Application No. 10 2017 119 928.4, filed Aug. 30, 2017, and each of which is incorporated herein by reference.

### FIELD OF THE INVENTION

The invention relates to a logistics system. The invention relates to a logistics system for carrying out a logistics process.

### BACKGROUND OF THE INVENTION

The industrial manufacture of goods is carried out in a production process in which, in terms of a smooth production flow, all raw, auxiliary, and operating materials needed for the production as well as semi-finished products and operating media and the like must be provided in a timely manner at the locations in the production process at which they are needed.

For example, in the production and filling of beverages in reusable packaging it is necessary to provide empty containers, which are temporarily stored at a suitable storage area in a warehouse until they are filled. For filling, the empty containers must be transported to a filling station, and after filling, the resulting full containers must once again be stored at a suitable location in the warehouse until they are picked up. The storage may take place, for example and in particular, in a rack storage unit, wherein within the scope of the logistics process, loads to be transported are transported by automated rack storage and retrieval apparatuses.

A logistics system is used to automatically carry out the logistical tasks in question within the scope of a logistics process.

### OBJECTS AND SUMMARY OF THE INVENTION

An object of the invention is to provide a logistics system for carrying out, for example, a production process or some other process that has a high level of flexibility with regard to the spatial arrangement of the various stations of the process, and in particular with regard to a change in this spatial arrangement.

This invention is achieved by the invention set forth herein.

The invention provides a logistics system for carrying out a logistics process having a plurality of automated overhead rack storage and retrieval apparatuses for transporting loads to be transported within the scope of the logistics process, and a plurality of spaced-apart guide apparatuses for the rack storage and retrieval apparatuses, wherein the rack storage and retrieval apparatuses are designed in such a way that they are movable along the guide apparatuses. A control apparatus is provided for controlling the rack storage and retrieval apparatuses. The loads to be transported may be unit loads, for example.

The logistics system according to the invention has a process zone that is situated on the floor, and that is essentially free of storage racks and has a process zone base area. A storage zone in which storage areas for storing loads are situated is formed above the process zone. The storage zone has a storage zone base area.

The process that is carried out in the process zone may be any process in which goods of any type are in particular manufactured and/or processed and/or picked and/or stored. For example and in particular, the process may be a production process, so that the process zone forms a production zone.

A first guide apparatus and a second guide apparatus are each associated with an edge of the storage zone base area that extends along a first extension of the storage zone base area, and extend essentially over the entire length of the particular edge, wherein a plurality of pick-up or drop-off points at which loads may be picked up or dropped off by the rack storage and retrieval apparatuses is defined along the process zone base area, and wherein the control apparatus is programmed in such a way that the pick-up and drop-off points are accessible or are accessed by the rack storage and retrieval apparatuses as needed, based on the logistics process.

The invention provides a process zone that is situated on the floor in the vertical direction and that has a design that is essentially free of storage racks. According to the invention, a process zone that is essentially free of storage racks is understood to mean a surface on which no racks are fixedly anchored to the floor, so that pick-up and drop-off points may be freely defined and optionally redefined on an appropriate surface in the manner according to the invention.

Accordingly, in particular movable auxiliary racks or other storage aids may be present while maintaining the basic principle according to the invention, and without conflicting with same.

If the process zone is situated within an overall surface, for example a storage zone overall surface, on which storage racks are fixedly anchored to the floor, the process zone is defined as the portion of the overall surface that is free of storage racks, within which the basic principle according to the invention may be carried out without limitations.

The storage racks required for the storage and retrieval of loads within the scope of the logistics process are present in a storage zone that is situated above the process zone. A clearance is thus created in the process zone beneath the storage zone, wherein the entire base surface of the process zone or at least a significant portion thereof remains free, except for structural support elements which, for example, may support a storage rack in particular at the edge of the process zone, and on which the storage areas are formed. Stations of the process, for example and in particular a production process, may be built or arranged in this area with a high level of spatial flexibility.

By appropriate programming of the control apparatus for defining associated pick-up and drop-off points, the stations of the production process or some other process may be accessed by the rack storage and retrieval apparatuses in order to pick up or drop off loads.

According to the invention, a plurality of pick-up or drop-off points at which loads may be picked up or dropped off by the rack storage and retrieval apparatuses is definable or defined depending on the circumstances of the logistics process, wherein the control apparatus is programmed in such a way that the pick-up or drop-off points are accessible or are accessed by the rack storage and retrieval apparatuses as needed, based on the logistics process.

In practical terms, the various stations of a production process, for example, may thus be situated on the process zone base area with complete freedom in terms of an efficient production flow.

For the supply and return transport of loads to be transported within the scope of the logistics process, at the corresponding stations or other relevant locations in the logistics process pick-up and drop-off points may be freely defined, which are then accessed by the rack storage and retrieval apparatuses according to appropriate programming of the control apparatus. Since the rack storage and retrieval apparatuses used according to the invention are overhead rack storage and retrieval apparatuses, support of the rack storage and retrieval apparatuses on the floor is not necessary, so that in this regard the process zone base area remains clear.

In this way, the highest possible flexibility is achieved with regard to the spatial arrangement of the stations of the process, for example a production process.

According to the invention, the pick-up and drop-off points may be defined in particular along a matrix that is overlaid on the process zone. This matrix may be defined or influenced by the static support structure of a building in which the logistics system is situated.

A particular advantage of the logistics system according to the invention is that the spatial arrangement of the stations of the process relative to one another may be easily and quickly changed according to the particular requirements, for example by spatially displacing a station and correspondingly relocating the associated pick-up or drop-off point. In the simplest case, only reprogramming of the control apparatus is necessary for this purpose. If safety devices for the overhead rack storage and retrieval apparatuses are provided at the pick-up or drop-off points, these safety devices may also be spatially repositioned relatively easily.

The logistics system according to the invention is usable, for example and in particular, within the scope of production processes for any given goods.

According to the invention, it is possible in principle to use one or at least one overhead rack storage and retrieval apparatus at each guide apparatus. One extremely advantageous further embodiment of the invention provides at least one transverse guidance apparatus along a second extension of the storage zone base area transverse to the first extension, wherein at least one transfer apparatus for transferring at least one rack storage and retrieval apparatus between two guide apparatuses and that is controllable by the control apparatus and movable along the transverse guidance apparatus is provided. A rack storage and retrieval apparatus may thus be transferred from one guide apparatus to another. It is thus possible on the one hand to keep fewer overhead rack storage and retrieval apparatuses as guide apparatuses on hand in the logistics system in order to reduce the equipment outlay for the logistics system, which is determined primarily by the overhead rack storage and retrieval apparatuses. At the same time, however, it is ensured that all logistical tasks in question may be carried out by transferring rack storage and retrieval apparatuses as needed. On the other hand, by transferring rack storage and retrieval apparatuses as needed, this embodiment also provides the option of creating an arrangement in which more than one rack storage and retrieval apparatus is temporarily available on at least one guide apparatus.

The shape, size, and configuration of the guide apparatuses are selectable within wide limits, depending on the particular requirements. One advantageous further embodiment provides that the guide apparatuses are essentially equidistantly spaced along the second extension.

One advantageous further embodiment of the invention provides that the guide apparatuses extend in a straight line. The design of the guide apparatuses is simplified in this way. In practical terms, the guide apparatuses may be rails or rail systems, for example, on which a base body of an overhead rack storage and retrieval apparatus is movable by means of a drive, with a load pick-up means that is suspended on cables, for example, being situated on the base body.

Another further embodiment of the invention provides that the guide apparatuses extend in parallel to one another.

The transfer path for the transfer of a rack storage and retrieval apparatus by a transfer apparatus may extend along any suitable path, depending on the particular requirements. In this regard, one advantageous further embodiment of the invention provides that at least one transfer apparatus is designed for transferring at least one rack storage and retrieval apparatus along a transfer path that extends transversely with respect to the first extension of the storage zone base area.

In principle, at least one transfer apparatus may be situated at the edges of the storage zone base area that extend along the second extension. In other words, the transfer apparatus is then situated at one end of the guide apparatus. In this regard, one advantageous further embodiment of the invention provides that at least one transfer apparatus is situated remote from the ends of the edges of the storage zone base area that extend along the second extension.

To further increase the flexibility in the transfer of rack storage and retrieval apparatuses, another advantageous further embodiment of the invention provides at least two transfer apparatuses that are spaced apart along the first extension.

According to one advantageous further embodiment of the invention, at least one guide apparatus has an uninterrupted design along the first extension. In this way, the guide apparatus may be formed by a continuous rail or rail system, for example.

However, it is also possible according to the invention for at least one guide apparatus along the first extension to be formed by multiple successive and directly adjoining guide apparatus sections. In this embodiment, the guide apparatus is formed by multiple shorter guide apparatus sections.

A further embodiment of the above-mentioned embodiment provides that the transfer path of at least one transfer apparatus extends between two guide apparatus sections.

One extremely advantageous further embodiment of the invention provides that the control apparatus for controlling at least one transfer apparatus is programmed in such a way that at least two rack storage and retrieval apparatuses are available as needed on at least one guide apparatus. It is thus possible to provide multiple rack storage and retrieval apparatuses simultaneously on a guide apparatus, as needed, when, for example, a particularly high level of pick-up or drop-off activity is temporarily needed at individual pick-up or drop-off points.

Another advantageous further embodiment of the invention provides that the storage zone has at least one rack storage unit in which the storage areas are situated.

In the above-mentioned embodiment the rack storage unit may be advantageously designed as a high-bay rack storage unit, as provided by another advantageous further embodiment.

A further embodiment of the above-mentioned embodiments provides that the storage rack forms a single-bay storage unit, at least in areas.

However, other storage variants are also possible, depending on the particular requirements. For example, according to one advantageous further embodiment the rack may be designed, at least in areas, for multi-depth storage.

The logistics system according to the invention is highly versatile. One advantageous further embodiment provides that the logistics system is designed and configured for incorporating a production process in such a way that the rack storage and retrieval apparatuses are provided for transporting raw, auxiliary, or operating materials, operating media, semi-finished products, finished products, or other goods, wherein the process zone forms a production zone.

The invention is explained in greater detail below based on embodiments, with reference to the appended highly schematic drawings.

All features described, illustrated in the drawings, and claimed in the patent claims, alone or in any suitable combination, constitute the subject matter of the invention, regardless of their recapitulation in the patent claims or their back-reference, and regardless of their description, or illustration in the drawings.

It is apparent to those skilled in the art that the features of one embodiment may also be combined with the features of one or more other embodiments. In addition, it is apparent to those skilled in the art that the individual features further embody the particular embodiment taken by themselves, i.e., independently of the other features of the particular embodiment.

Relative terms such as left, right, up, and down are for convenience only and are not intended to be limiting.

### BRIEF DESCRIPTION OF THE DRAWINGS

In the figures:

FIG. 1 shows a highly schematic side view of a first embodiment of a logistics system according to the invention,

FIG. 2 shows a plan view of the logistics system according to FIG. 1,

FIG. 3 shows, in the same illustration as FIG. 2, a second embodiment of a logistics system according to the invention, and

FIG. 4 shows, in the same illustration as FIG. 2, a third embodiment of a logistics system according to the invention.

### DETAILED DESCRIPTION OF THE INVENTION

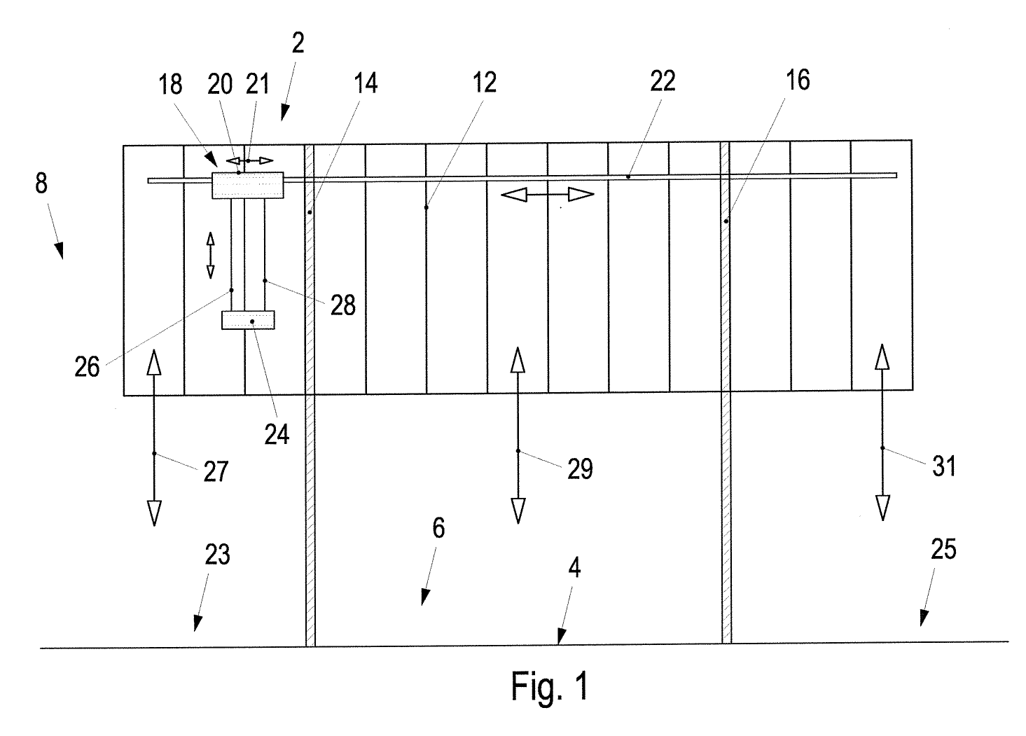

Embodiments of a logistics system according to the invention are explained in greater detail below with reference to FIGS. 1 through 4.

Identical or corresponding parts are provided with the same reference numerals in the figures of the drawing.

FIG. 1 illustrates a highly schematic side view of one embodiment of a logistics system 2 according to the invention for carrying out a logistics process.

The logistics system 2 has a process zone 6 which is situated on the floor 4, and which in this embodiment is designed essentially free of storage racks. A storage zone 8 in which storage areas for storing loads are situated is formed above the process zone 6.

The process that is carried out in the process zone 6 during operation of the logistics system 2 may be any process in which goods of any type are in particular manufactured and/or processed and/or picked and/or stored. For example and in particular, the process may be a production process, so that the process zone 6 forms a production zone.

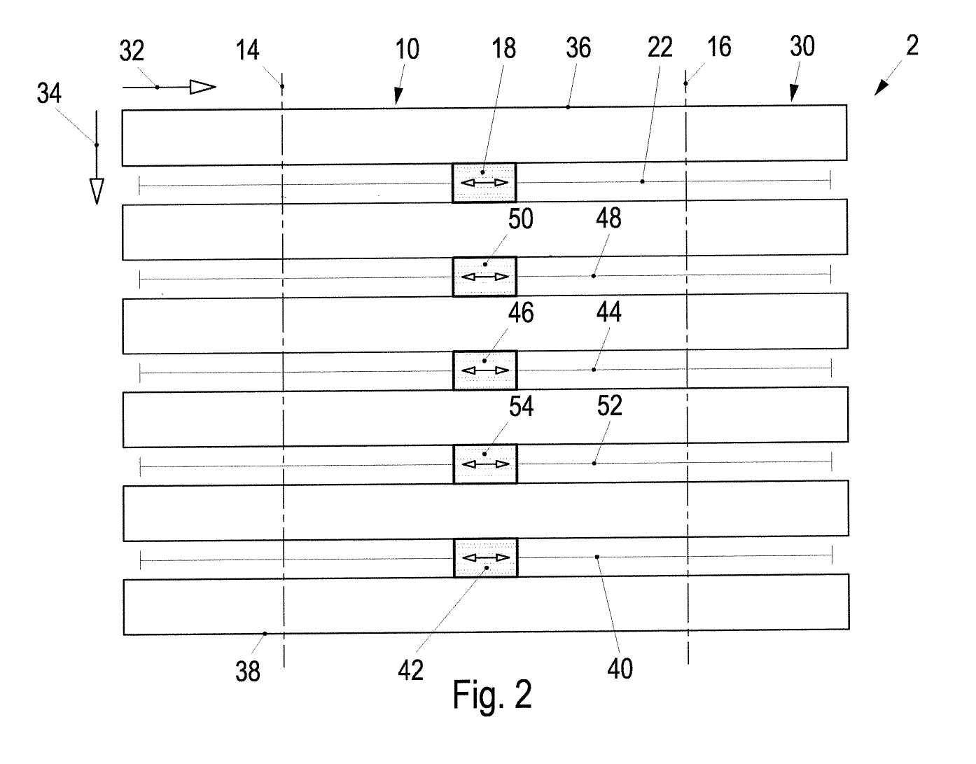

Since the process zone 6 has a design that is essentially free of storage racks, a process zone base area 10 of the process zone 6 (see FIG. 2) on the floor remains clear. By use of the overall associated infrastructure, stations of the process, such as a production process, may be arranged and distributed in practically any desired manner along the process zone base area 10 of the process zone 6 (see FIG. 2), depending on the requirements of the particular process.

The storage zone 8 has a rack storage unit 12 (see FIG. 1), which in this embodiment is designed as a single-bay storage unit and has a plurality of storage areas in which loads occurring within the scope of the process may be stored. The storage zone 8 has a storage zone base area 30 (see FIG. 2) that corresponds to the surface that is covered by the rack storage unit 12.

Support structure elements that support racks of the rack storage unit 12 on the floor 4 are only schematically indicated by reference numerals 14, 16 in FIG. 1. The support structure elements 14, 16 may be situated outside the process zone base surface 10, so that the process zone base area 10 is still free for providing stations of the process.

If necessary, however, depending on the particular requirements, the support structure elements 14, 16 may also be supported within the process zone base area 10. Since this may involve support on a relatively small surface, the clearance space on the process zone base area 10 for forming the process zone 6 is not significantly affected.

The logistics system 2 according to the invention has a plurality of automated overhead rack storage and retrieval apparatuses, of which an overhead rack storage and retrieval apparatus 18 is schematically indicated by way of example in FIG. 1. The rack storage and retrieval apparatuses are used for transporting loads to be transported within the scope of the logistics process.

The overhead rack storage and retrieval apparatus 18 has a base body 20 that is movable along a guide apparatus 22 in the direction of a double arrow 21 by means of a drive. The guide apparatus 22 may be formed by a rail system, for example, on which the base body 20 of the overhead rack storage and retrieval apparatus 18 runs.

The overhead rack storage and retrieval apparatus 18 has a load pick-up means 24, which in this embodiment is suspended on cables 26, 28. In other respects, the design of corresponding overhead rack storage and retrieval apparatuses is generally known to those skilled in the art, and therefore is not explained in greater detail. In this regard, reference is made in particular to EP 1 390 286 B2, EP 1 575 851 B2, EP 1 446 353 B2, EP 2 119 661 B2, EP 2 116 503 B2, EP 2 138 427 B2, EP 2 318 291 B2, DE 10 2009 051 792 A1, DE 10 2009 051 800 A1, and EP 325 111 B2, whose entire disclosed content is hereby incorporated by reference into the present patent application.

In the context of the invention, the advantage of an overhead rack storage and retrieval apparatus, among others, is that due to the fact that operation of the rack storage and retrieval apparatuses does not take place from the floor, installations on the floor 4, as required in the use of floor-mounted rack storage and retrieval apparatuses, are not necessary.

For controlling the rack storage and retrieval apparatus 18 and the other rack storage and retrieval apparatuses of the logistics system 2, a control apparatus is provided which may be formed, for example, by a central control computer of the logistics system.

FIG. 2 shows a plan view of the logistics system 2 according to FIG. 1. As is apparent from FIG. 2, the logistics system 2 in this embodiment is situated on an essentially rectangular layout that is defined by a building in which the logistics system 2 is situated. Any other desired layouts are possible according to the invention, depending on the particular requirements and the spatial or building-related circumstances and conditions.

In the illustrated embodiment, a first extension, symbolized by an arrow 32 in FIG. 2, corresponds to a longitudinal extension of the storage zone base area 30, while a second extension, symbolized by an arrow 34, corresponds to a transverse extension of the storage zone base area 30.

A first guide apparatus (guide apparatus 22) and a second guide apparatus 40 are associated with the edges 36, 38, respectively, of the storage zone base area 30 that extend in the direction of the longitudinal extension 32 (see FIG. 2). The rack storage and retrieval apparatus 18 is situated on the first guide apparatus 22, while a second rack storage and retrieval apparatus 42 is situated on the second guide apparatus 40.

A third guide apparatus 44 having a third rack storage and retrieval apparatus 46 is situated at a distance between the first guide apparatus 22 and the second guide apparatus 40 in the direction of the transverse extension 34 of the storage zone base area 30.

In addition, a fourth guide apparatus 48 having a fourth rack storage and retrieval apparatus 50 is situated between the first guide apparatus 22 and the third guide apparatus 44 in the direction of the transverse extension 34, while a fifth guide apparatus 52 having a fifth rack storage and retrieval apparatus 54 is situated between the second guide apparatus 40 and the third guide apparatus.

The number of guide apparatuses and rack storage and retrieval apparatuses is selectable within wide limits, depending on the particular requirements.

As is apparent from FIG. 2, in the illustrated embodiment the guide apparatuses 22, 40, 44, 48, 52 are arranged in a straight line and are equidistantly spaced in the direction of the transverse extension 34.

The guide apparatuses 40, 44, 48, 52 and the rack storage and retrieval apparatuses 42, 46, 50, 54 are designed as previously described for the guide apparatus 22 and for the rack storage and retrieval apparatus 18. Therefore, they are not explained in greater detail here.

According to the invention, a plurality of pick-up and drop-off points at which loads may be picked up or dropped off by the rack storage and retrieval apparatuses 18, 42, 46, 50, 54 is defined along the process zone base area 10, wherein the control apparatus is programmed in such a way that the pick-up and drop-off points are accessed as needed by the rack storage and retrieval apparatuses 18, 42, 46, 50, 54, based on the logistics process.

The pick-up and drop-off points may be arranged in particular corresponding to a matrix that is overlaid on the process zone base area 10, in FIG. 2 the rows of the matrix being defined by the guide apparatuses 22, 40, 44, 48, 52, and the columns of the matrix being defined by positions that may be accessed by the rack storage and retrieval apparatuses 18, 42, 46, 50, 54 along the guide apparatuses 22, 40, 44, 48, 52. If the rack storage and retrieval apparatuses 18, 42, 46, 50, 54 are able to access along the associated guide apparatus 22, 40, 44, 48, 52 by control means, the columns of the matrix directly adjoin one another.

Thus, in principle, any given point in the process zone base area 10 may be accessed by the rack storage and retrieval apparatuses 18, 42, 46, 50, 54 along the guide apparatuses 22, 40, 44, 48, 52 for dropping off or picking up loads. Within the scope of the logistics process, required pick-up and drop-off points in the process zone 6 may thus be freely defined by appropriate programming of the control apparatus, and if necessary, may be redefined by appropriate reprogramming of the control apparatus.

This results in an extremely high level of flexibility of the logistics system 2, in particular with regard to the arrangement and optionally rearrangement of the pick-up and drop-off points in the process zone 6.

As is apparent from FIG. 1, the guide apparatuses 22, 40, 44, 48, 52 extend over the entire length of the storage zone base area 30, so that any given locations in the storage zone base area 30, and thus also in the process zone base area 10, may be accessed by means of the rack storage and retrieval apparatuses 18, 42, 46, 50, 54 along the guide apparatuses 22, 40, 44, 48, 52 for picking up or dropping off loads.

During operation of the logistics system 2 according to the invention, stations of a production process or of some other process are situated in the process zone 6. Loads to be transported during the process may be picked up or dropped off by the rack storage and retrieval apparatuses 18, 42, 46, 50, 54 at the defined pick-up or drop-off points, depending on the requirements.

For example, finished or intermediate products produced within the scope of the process may be stored or temporarily stored at storage areas in the storage zone 8. The same applies for raw, auxiliary, and operating materials as well as operating media and other materials or aids needed within the scope of the process.

Due to it being possible to situate the stations of the process in the process zone base area 10, which is free of storage racks, in practically any desired manner, a particularly high level of freedom results with regard to this arrangement. In particular, for example the production stations of a production process may thus be arranged and optionally rearranged as necessary for optimizing the production process.

One particular advantage of the logistics system 2 according to the invention is that the spatial arrangement of the production stations may be changed relative to one another in a simple and flexible manner. While maintaining the basic principle of the invention, in this case it is necessary only to reprogram the control apparatus for taking into account the pick-up or drop-off points that have changed due to the altered spatial arrangement.

For example, a production process in which beverages are produced may be integrated into the logistics system. The process zone thus forms a production zone.

In the illustrated embodiment, the storage zone base area 30 occupies the entire base surface of the building in which the logistics system 2 is installed. In contrast, the process zone base area 10 occupies only the portion of the overall base surface, and thus of the storage zone base area 30, that is situated along the longitudinal extension between the support structure elements 14, 16 as indicated by dash-dotted lines in FIG. 2.

In the illustrated embodiment, a portion of the storage zone base area 30 situated to the left of the process zone base area 10 in FIG. 1 forms a delivery zone 23 in which empty containers are delivered by external transport vehicles. The delivered empty containers may be picked up by the overhead rack storage and retrieval apparatuses in the delivery zone 23 and, for example in the form of unit loads, stored at storage areas in the rack storage unit 12.

In the course of the production process, the empty containers are then transported by means of the overhead rack storage and retrieval apparatuses into the production zone 6, where all production steps necessary for the production of beverages are carried out, and at the end of which the beverages are filled into bottles or other containers.

The resulting full containers may be picked up in the form of unit loads in the production zone 6 by the overhead rack storage and retrieval apparatuses, and are either temporarily stored in the rack storage unit 12 or transported directly into a pick-up zone 25.

In the illustrated embodiment, the pick-up zone 25 is formed by a portion of the storage zone base area 30 to the right of the process zone base area 10 in FIG. 1. In the pick-up zone, the full containers are provided for pickup by external transport vehicles.

It is indicated by double arrows 27, 29, and 31 in FIG. 1 that the overhead rack storage and retrieval apparatuses can access the production zone (arrow 29), the delivery zone 23 (arrow 27), and the pick-up zone 25 (arrow 31).

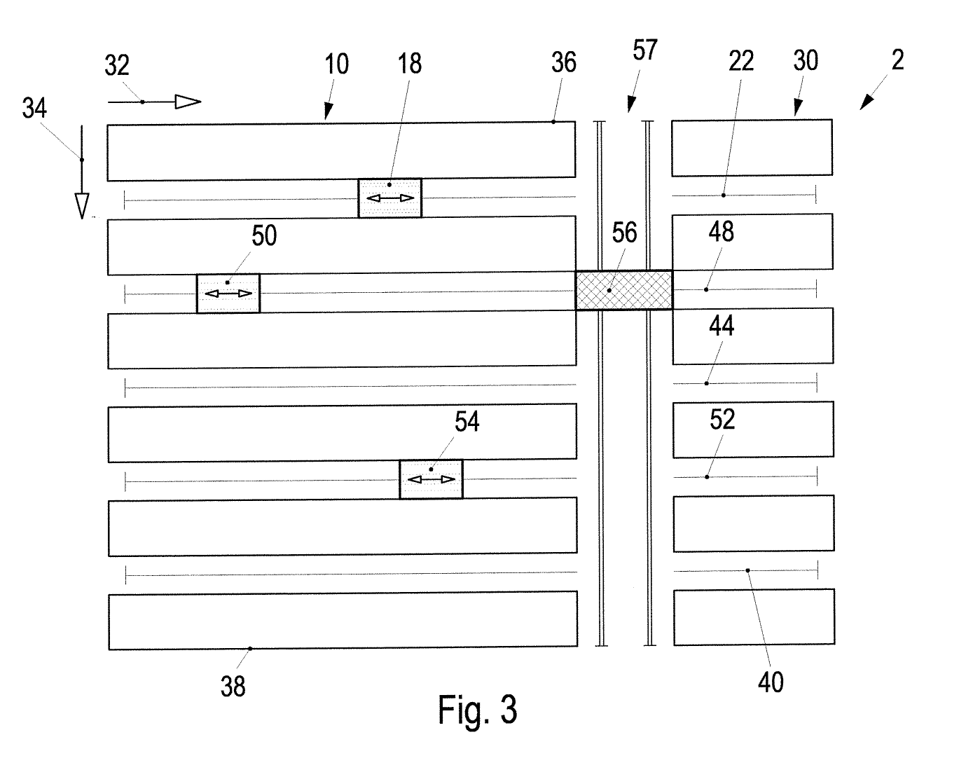

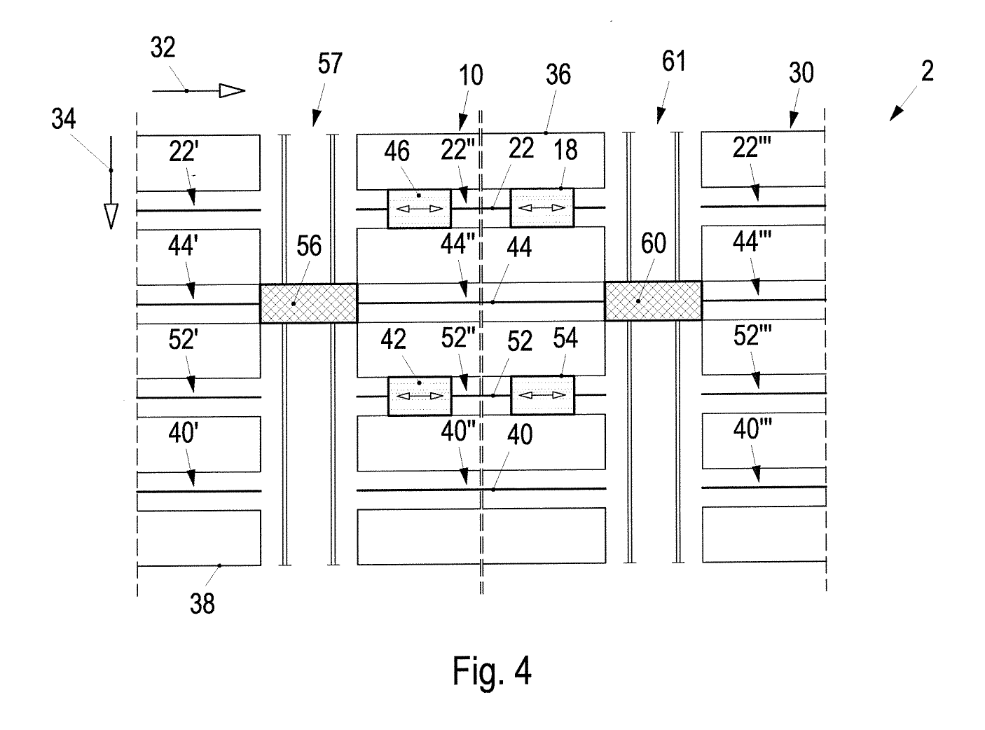

FIGS. 3 and 4 illustrate additional embodiments of a logistics system 2 according to the invention, which differ from the embodiment according to FIGS. 1 and 2 in that it is possible to transfer rack storage and retrieval apparatuses between guide apparatuses.

FIG. 3 illustrates a third embodiment of a logistics system 2 according to the invention in which five guide apparatuses 22, 40, 44, 48, 52 are provided corresponding to FIG. 2, and in a departure from FIG. 2, an individual transfer apparatus 56 is additionally provided which is movable along a transverse guidance apparatus 57 that extends in the direction of the transverse extension 34. In the illustrated embodiment, three rack storage and retrieval apparatuses 18, 50, 54 are provided by means of which all pick-up and drop-off points that are provided in the embodiment may be accessed. For this purpose, the rack storage and retrieval apparatuses 18, 50, 54 are appropriately transferred as needed by means of the transfer apparatus 56.

FIG. 4 illustrates a third embodiment of a logistics system 2 according to the invention in which four guide apparatuses 22, 40, 44, 52 and four rack storage and retrieval apparatuses 18, 42, 46, 54 are provided.

In a departure from the embodiment according to FIG. 3, in the embodiment according to FIG. 4 two transfer apparatuses 56, 60 having associated transverse guidance apparatuses 57, 61, respectively, and which are controllable by the control apparatus, are provided for transferring at least one rack storage and retrieval apparatus between two of the guide apparatuses 22, 40, 44, 52. The transfer apparatuses 56, 60 are used for transferring a rack storage and retrieval apparatus as needed from one guide apparatus to another guide apparatus.

The design of such a transfer apparatus 56, 60 is generally known to those skilled in the art, and therefore is not explained in greater detail here. In this regard, reference is made in particular to DE 102 40 095 A1, whose entire disclosed content is hereby incorporated by reference into the present patent application.

As is apparent from FIG. 4, the transfer path of the transfer apparatus 56 extends along the transverse guidance apparatus 57 essentially transversely with respect to the guide apparatuses 22, 40, 44, 52, wherein the transfer path interrupts the guide apparatuses 22, 40, 44, 52.

As is apparent from FIG. 4, the transfer apparatus 56 is situated remote from the ends of the storage zone base area 30.

The transfer apparatus 60 is provided similarly as for the transfer apparatus 56, and is spaced apart from the transfer apparatus 56 in the direction of the longitudinal extension 32. As a result of the guide apparatuses 22, 40, 44, 52 being interrupted by the transverse guidance apparatuses 57, 61, for example the guide apparatus 22 is formed by three successive guide apparatus sections 22′, 22″, and 22′″ in the direction of the longitudinal extension 32. The same applies for the guide apparatuses 40, 44, 52.

The rack storage and retrieval apparatuses 18, 42, 46, 54 for any of the guide apparatuses 22, 40, 44, 52 or the guide apparatus sections thereof may be transferred by means of the transfer apparatuses 56, 60.

FIG. 4 shows a configuration in which the rack storage and retrieval apparatuses 18, 46 are situated on the guide apparatus section 22″, and the rack storage and retrieval apparatuses 42, 54 are situated on a guide apparatus section 52″ of the guide apparatus 52.

The number of guide apparatuses, rack storage and retrieval apparatuses, and transfer apparatuses is selectable within wide limits, depending on the particular requirements.

In particular, configurations are possible in which at least one rack storage and retrieval apparatus is associated with each guide apparatus by default. Configurations are also possible in which the number of rack storage and retrieval apparatuses is less than the number of guide apparatuses, so that the various pick-up or drop-off points associated with various guide apparatuses are operated by the at least one rack storage and retrieval apparatus.

However, according to the invention in particular configurations are also possible in which more than one rack storage and retrieval apparatus is associated with a guide apparatus by default. Accordingly, two or more rack storage and retrieval apparatuses may be permanently associated with at least one guide apparatus.

However, it is also possible according to the invention to associate two or more rack storage and retrieval apparatuses only temporarily with a guide apparatus when there is such a need for pick-up and drop-off points to be associated with this guide apparatus.

The invention provides a logistics system that is characterized above all by a particularly high level of flexibility.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

1. A logistics system for carrying out a logistics process, comprising:
a) a plurality of automated overhead rack storage and retrieval apparatuses for transporting loads to be transported within the scope of the logistics process;
b) a plurality of spaced-apart guide apparatuses for the rack storage and retrieval apparatuses, and the rack storage and retrieval apparatuses are designed in such a way that they are movable along the guide apparatuses;
c) a control apparatus for controlling the rack storage and retrieval apparatuses;
d) a process zone that is situated on the floor, and that is essentially free of storage racks and has a process zone base area;
e) a storage zone, situated above the process zone, in which storage areas for storing loads are situated, and having a storage zone base area;
f) a first guide apparatus and a second guide apparatus are each associated with an edge of the storage zone base area that extends along a first extension of the storage zone base area, and extends essentially over the entire length of the particular edge;
g) a plurality of pick-up or drop-off points at which loads may be picked up or dropped off by the rack storage and retrieval apparatuses is defined along the process zone base area; and
h) the control apparatus is programmed in such a way that the pick-up and drop-off points are accessible or are accessed by the rack storage and retrieval apparatuses as needed, based on the logistics process.

2. The logistics system according to claim 1, wherein:
a) at least one transverse guidance apparatus is situated along a second extension of the storage zone base area transverse to the first extension; and
b) at least one transfer apparatus for transferring at least one rack storage and retrieval apparatus between two guide apparatuses and that is controllable by the control apparatus and movable along the transverse guidance apparatus is provided.

3. The logistics system according to claim 1, wherein:
a) the guide apparatuses that extend along the first extension are essentially equidistantly spaced along the second extension.

4. The logistics system according to claim 2, wherein:
a) the guide apparatuses and the at least one transverse guidance apparatuses extend in a straight line.

5. The logistics system according to claim 4, wherein:
a) the guide apparatuses extend in parallel to one another.

6. The logistics system according to claim 2, wherein:
a) at least one transfer apparatus is designed for transferring at least one rack storage and retrieval apparatus along a transfer path that extends transversely with respect to the first extension of the storage zone base area.

7. The logistics system according to claim 6, wherein:
a) the at least one transfer apparatus is situated remote from the ends of the edges of the storage zone base area that extend along the second extension.

8. The logistics system according to claim 6, wherein:
a) the at least one transfer apparatus includes at least two transfer apparatuses that are spaced apart along the first extension.

9. The logistics system according to claim 6, wherein:
a) the transfer path of at least one transfer apparatus, viewed toward the process zone base area, extends essentially transversely with respect to the guide apparatuses.

10. The logistics system according to claim 1, wherein:
a) at least one guide apparatus has an uninterrupted design along the first extension.

11. The logistics system according to claim 1, wherein:
a) at least one guide apparatus along the first extension is formed by multiple successive and directly adjoining guide apparatus sections.

12. The logistics system according to claim 11, wherein:
a) the transfer path of at least one transfer apparatus extends between two guide apparatus sections.

13. The logistics system according to claim 6, wherein:
a) the control apparatus for controlling at least one transfer apparatus is programmed in such a way that at least two rack storage and retrieval apparatuses are available as needed on at least one guide apparatus.

14. The logistics system according to claim 1, wherein:
a) the storage zone has at least one rack storage unit in which the storage areas are situated.

15. The logistics system according to claim 14, wherein:
a) the rack storage unit is designed as a high-bay rack storage unit.

16. The logistics system according to claim 14, wherein:
a) the rack storage unit forms a single-bay storage unit, at least in areas.

17. The logistics system according to claim 14, wherein:
a) the rack storage unit is designed, at least in areas, for multi-depth storage.

18. The logistics system according to claim 1, wherein:
a) the logistics system is designed and configured for incorporating a production process in such a way that the rack storage and retrieval apparatuses are provided for transporting and/or storing raw, auxiliary, or operating materials, operating media, semi-finished products, finished products, or other goods, and the process zone forms a production zone.
